(19) United States
(12) Patent Application Publication
(10) Pub. No.: US 2003/0230026 A1
(43) Pub. Date: Dec. 18, 2003

(54) Modular garden fencing

(76) Inventor: Ed Dillon, North Little Rock, AR (US)

Correspondence Address: Dennis B. Haase, Esq., Post Office Box 3592, Little Rock, AR, 72203, US

(21) Appl. No.: 10/172,456

(22) Filed: Jun. 17, 2002

(51) Int. Cl. A01G 1/00

(52) U.S. Cl. 47/33

(57) ABSTRACT

A series of modular panels which are capable of being serially inter engaged to form an enclosure, and including at least one spike at the base of each of such panels to secure each of the panels to the earth. The panels are interspersed with a number of symmetrically spaced openings, each of which is, in and of itself, an attractive geometric shape.

The present invention relates primarily to domestic gardening materials and, more particularly, to a series of novel panels which are capable to being conjoined to encircle a predetermined area of a garden which, in addition to defining that particular area, protects against the incursion of ambulatory pests and beautifies the region.

### BACKGROUND OF THE INVENTION

1. Field of the Invention

The family garden, once a necessary effort to provide vegetables and other food stuffs, has been elevated, with the advent of supermarkets, first to the status of hobby and then, in many cases, to a passion.

Gardeners, like other hobbyists, are eternally vigilant in their pursuit of items which will enhance their efforts. Among the problems which plague the gardener is the incursion of four footed predators such as rabbits, squirrels, and various members of the rodent family.

A situation unrelated to the predator issue, but requiring a similar solution is the training and support of vine like plants, e.g., tomatoes. Further, gardeners often wish to segregate portions, if not all of the area dedicated to their pursuits, and to do so in a manner that is aesthetic as well as efficient, and all of these matters are capable of a single resolution, as will become evident as a reading of this specification proceeds.

2. Overview of Related Prior Art

While many gardeners are innovators of a sort, who never concern themselves with the commercialization of their ideas, there have been several who have sought and gained patent protection in this field.

Typical of many efforts in this field is the very early patent to Beasley, U.S. Pat. No. 936,402, for a plant support. The Beasley support appears one step removed from the well known stake.

Benson, Jr. U.S. Pat. No. 5,544,446, for a Collapsible and Adjustable Plant Support and Protector teaches essentially a wire fence made of stackable wire squares, as perhaps an improvement over Ringer U.S. Pat. No. 4,211,033, which combines an enclosure for compost with vine type plants supported about the periphery.

Elliott U.S. Pat. No. 5,640,802 is a stackable support for tomato plants, which grows vertically as the tomato plant grows. Nievilt U.S. Pat. No. 4,213,272 and Elbert U.S. Pat. No. 3,328,915 are both support devices which engage a vine plant about the trunk and are sophisticated versions of the very early Beasley patent referenced above.

### SUMMARY OF THE INVENTION

The present invention comprises a series of modular panels which are capable of being serially inter engaged to form an enclosure and including at least one spike at the base of each of such panels to secure each of the panels to the earth. The panels are interspersed with a number of openings, each of which is geometric in shape, all of which is intended to accomplish the various objectives of the invention.

More specifically, it is an objective of the present invention to permit a gardener to create a structure about the perimeter of a defined space, wherein various plants, including vine type plants, are grown by the gardener. It is an additional objective to provide such a structure which is of sufficient height and stability so as to inhibit predators, as well as the curious, from entering the defined area to eat, or otherwise damage, the plants growing there within.

It is another objective of the present invention to provide a plurality of modular panels which are capable of being interconnected to define a decorative fence about a garden, or defined portion thereof.

An objective closely related to the foregoing is to provide a structure formed of modular panels having a number of openings formed therein, to which vine type plants may be secured during growth to support them against the weight of the fruits and vegetables growing thereon.

The foregoing, as well as other objects and advantages of the present invention, will become apparent to one skilled in the art from a reading of the Detailed Description of a Preferred Embodiment, taken in conjunction with the drawings, wherein:

### DESCRIPTION OF THE DRAWINGS

FIG. 1 is pictorial representation of a portion of a structure comprised of a series of modular panels constructed in accordance with the present invention, providing a general idea of the panel construction and their interaction with one another;

FIG. 2A is a fragmentary view of a portion of contiguous panels, illustrating the structure of each which permits them to be interconnected;

FIG. 2B is a view similar to FIG. 2A, illustrating an alternative method of interconnecting the panels;

FIG. 3 is a sectional view of one of the panels of FIG. 1 taken along line 3-3 of FIG. 1;

FIG. 4 is a front side elevation of a panel constructed in accordance with the present invention and having a series of octagonal openings formed therein;

FIG. 5 is a rear side elevation of the panel of FIG. 4;

FIG. 6 is a panel in the nature of the panel of FIG. 4, with the openings therein having circular shapes; and,

FIG. 7 is similar in construction to the panels of FIGS. 4 and 6, with the exception that the openings formed therein are hexagonal.

### DETAILED DESCRIPTION OF A PREFERRED EMBODIMENT

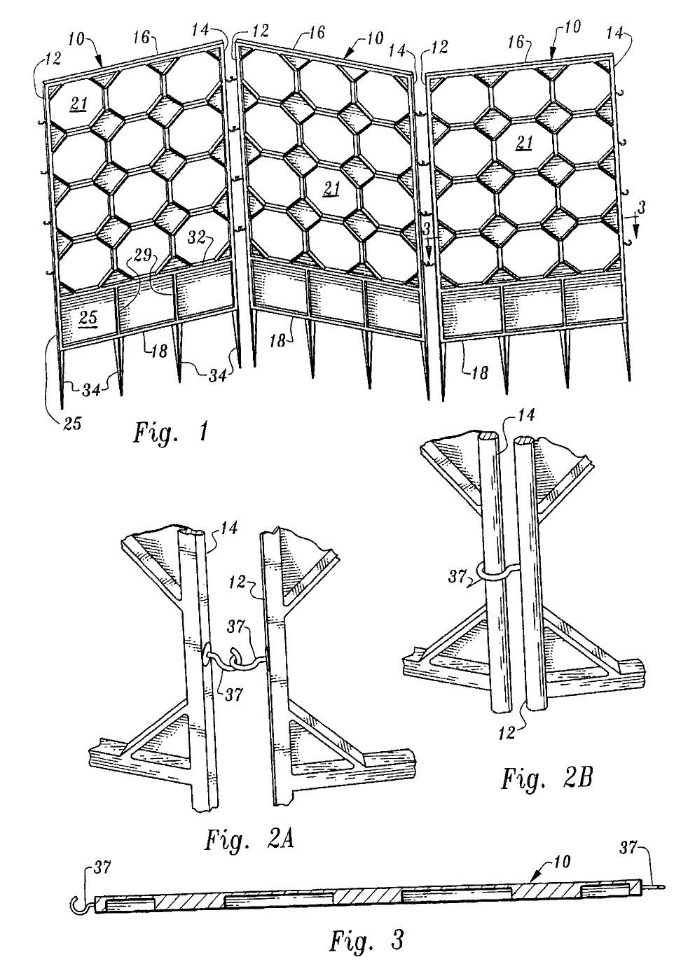

With reference initially to FIG. 1, there is illustrated a series of novel garden panels 10, constructed in accordance with the present invention.

Each of the panels 10 is generally rectangular in profile and is constructed, fabricated, or molded of a relatively inflexible material such as wood, or of a plastic material having the requisite structural integrity. Each such panel 10 is formed from a flat sheet of material. Side rails, or edges, 12 and 14 are provided along the longitudinal edges of each panel, and the space between them defines the width of each panel. A width of 18″ would appear to strike a balance between convenience in handling and a requirement for an inordinate number of panels to accomplish a particular task, although a width ranging between 12″ and 24″ would not be unrealistic, and panels of differing widths might provide an ability to more accurately define the area to be circumscribed by a structure comprised of panels of the present invention.

In a similar fashion, the invention contemplates transverse rails, or edges, 16, at the top of each panel 10, and 18, at the bottom thereof. The rails, or edges, 16 and 18 engage, intersect, or otherwise form integrally with, the longitudinal rails 12, 14 (vertical edges) at their respective termini to define the perimeter of the panel 10. Such a panel may be conveniently 36″ high, although, once again, the precise parameters allow for a variation in height, depending on use of at least plus or minus 10″ without diminishing the salutary effect of the panels as a structure.

The panel 10 may, in accordance with a feature of the invention, be fabricated, or formed, as a sheet of resident material such as wood, or may be molded, in the case of a suitable plastic, with an array of openings 21 to provide, in accordance with one aspect of the invention, a trellis effect for the support of vine or other creeping plants growing within the perimeter of a structure formed of interlocking panels, or adjacent to panels that are standing alone.

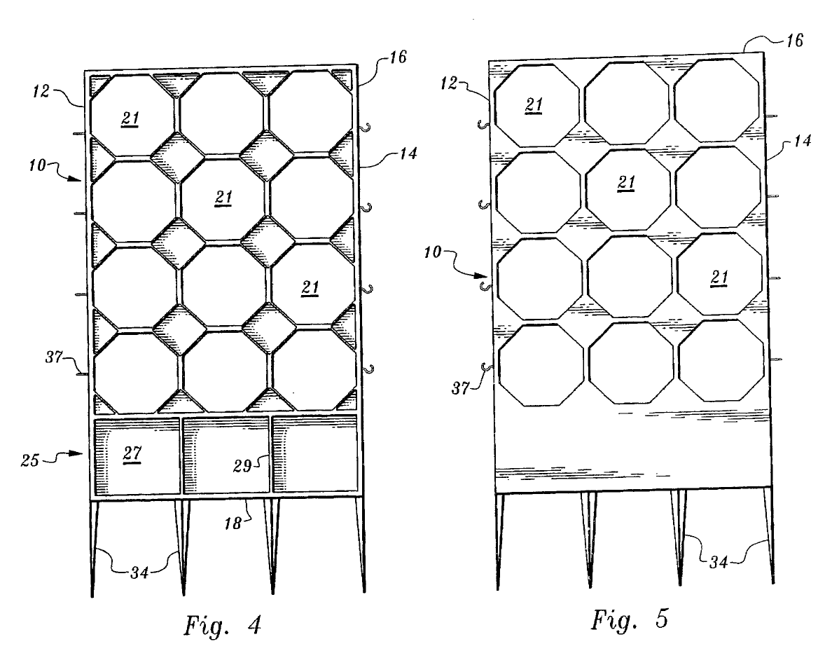

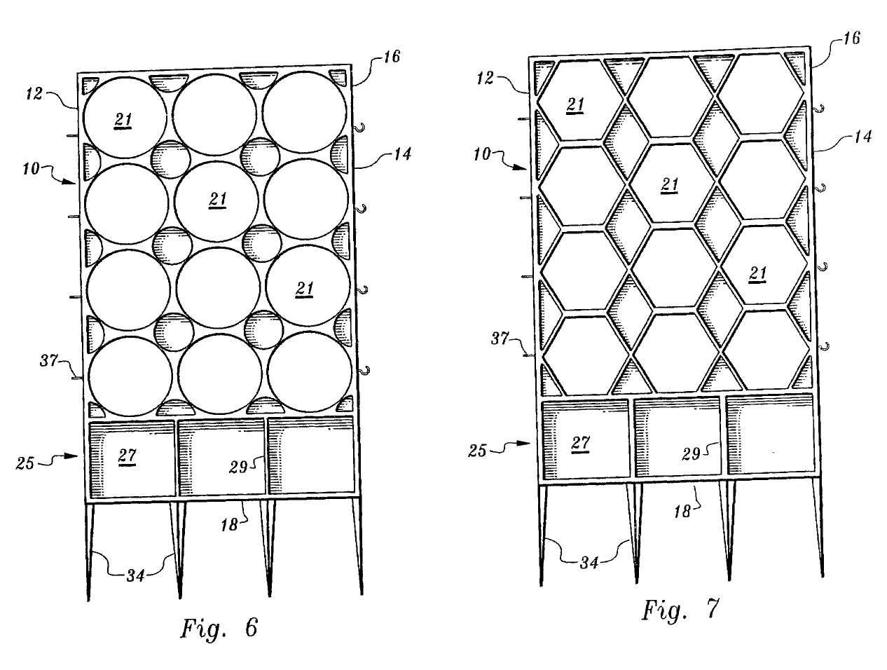

The openings 21, as may be seen in FIGS. 1 and 4 through 7, are symmetrically spaced in both the longitudinal and transverse axes of each panel and, in the case of the openings 21, are octagonally shaped, whereas they assume a hexagonal shape in FIG. 7 and a circular shape in FIG. 6. As seen in the various figures of the drawings, intertwined between the openings in symmetrical array are smaller geometric openings of the same shape as the larger openings. Such shapes have been found to be aesthetically pleasing, and, by placing the openings in a symmetrical pattern, there is a consistent uniformity and order to the panels which adds to their attractiveness, both individually and as a part of an overall structure. At the same time, structural integrity is maintained by the lattice work which remains upon formation of the openings 21.

In order to insure that unwanted predators are inhibited from attempting to traverse the barrier formed by panels 10 formed in a closed serial relationship to define a structure, the bottom portion of each panel is formed with an opaque screen, or blind, 25. The screen 25 is preferably integrally formed as part of the panel 10 and, as shown, comprises contiguous sections 27 defined by ribs 29 being vertically disposed between the transverse rail 18 and an intermediate rail 32. By making the screen 25 a height of 5″ to 6″ and, as previously stated, opaque, snakes, rodents, and such animals as rabbits are inhibited from attempts to traverse a structure formed of such panels.

Whether a panel 10 is free standing or part of an overall structure, it is important and expedient to be able to secure each such panel in the ground, and, to this end, at least one, and preferably four, spikes 34 are provided.

It is within the purview of the invention to form the spikes 34 integrally with the panels themselves and, by positioning them coaxially with vertical rails 12 and 14 and ribs 29, considerable additional axial strength is provided in order that the panels are readily positioned and secured in the ground by simply pushing down on the top transverse edge 16.

It is an important feature of the present invention that an enclosed structure is capable of being formed by a series of interconnected, serially spaced, panels 10, a portion of which is illustrated in FIG. 1.

To this end, and with reference to FIG. 2A, the longitudinal edges 12 and 14 are provided with fastening devices, e.g., hooks, 37, which are conveniently serially spaced at uniform distances along the vertical edges 12 and 14. In this manner, opposed hooks may be engaged with one another to conjoin contiguous panels, as seen in FIG. 1, to form a closed structure. It will be appreciated that instead of opposed hooks, as seen in FIG. 2A, an eye may be substituted along one of the edges without departure from the invention.

Having now described a preferred embodiment, together with certain variations, particularly in the openings 21, it will be appreciated that other variations are contemplated by the invention and will occur to those skilled in the art as being within the scope thereof.

What is now claimed is:

1. A sheet of material defining a panel for use in a garden for supporting a vine like plant, said panel having a series of symmetrically spaced openings; said openings having an attractive geometric shape, a screen disposed beneath said openings on said panel, said screen being opaque;
said panel terminating in at least one spike, said spike being adapted to penetrate the ground in order to anchor said panel in a predetermined position in the ground.

2. The panel of claim 1, wherein said openings are circular in shape.

3. The panel of claim 1, wherein said openings are octagonal in shape.

4. The panel of claim 1, wherein said openings are hexagonal in shape.

5. The panel of claim 1, wherein said openings are square in shape.

6. A structure for use in defining a specified area of a garden, said structure being defined by a series of interconnecting panels, said panels each comprising a sheet of material defining a panel, said panel having a series of symmetrically spaced openings; said openings having an attractive geometric shape, a screen disposed beneath said openings on said panel, said screen being opaque;
said panel terminating in at least one spike, said spike being adapted to penetrate the ground in order to anchor said panel, said panels together defining an enclosure.

7. The panel of claim 6, wherein said openings are circular in shape.

8. The panel of claim 6, wherein said openings are cotagonal in shape.

9. The panel of claim 6, wherein said openings are hexagonal in shape.

10. The panel of claim 6, wherein said openings are square in shape.

11. The panel of claim 6, wherein each panel has at least one hook, said hook extending outwardly from a vertical edge of said panel, said hooks on adjacent panels adapted to engage one another to interconnect said panels.

12. The panel of claim 6, wherein at least one hook extends outwardly from a vertical edge of each of said panels, said hook adapted to engage the vertical edge of an adjacent said panel to interconnect said panels.

13. The panel of claim 6, wherein a series of serially spaced hooks extend outwardly from a vertical edge of each of said panels, said hooks adapted to engage said vertical edge of an adjacent said panel to interconnect said panels.

14. The panel of claim 6, wherein at least one spike is provided contiguous with each vertical edge of said panels.
